(19) United States
(12) Patent Application Publication
(10) Pub. No.: US 2013/0163676 A1
(43) Pub. Date: Jun. 27, 2013

(54) METHODS AND APPARATUS FOR DECODING VIDEO SIGNALS USING MOTION COMPENSATED EXAMPLE-BASED SUPER-RESOLUTION FOR VIDEO COMPRESSION

(71) Applicants: Dong-Qing Zhang, Bridgewater, NJ (US); Mithun George Jacob, West Lafayette, IN (US); Sitaram Bhagavathy, Palo Alto, CA (US)

(72) Inventors: Dong-Qing Zhang, Bridgewater, NJ (US); Mithun George Jacob, West Lafayette, IN (US); Sitaram Bhagavathy, Palo Alto, CA (US)

(73) Assignee: THOMSON LICENSING, Issy de Moulineaux (FR)

(21) Appl. No.: 13/821,078

(22) PCT Filed: Sep. 9, 2011
(86) PCT No.: PCT/US2011/050915

§ 371 Date: Mar. 6, 2013

Related U.S. Application Data
(60) Provisional application No. 61/403,086, filed on Sep. 10, 2010.

(51) Int. Cl. H04N 7/26

(52) U.S. Cl. CPC H04N 19/00
USPC 375/240.25

(57) ABSTRACT

Methods and apparatus are provided for decoding video signals using motion compensated example-based super-resolution for video compression. An apparatus includes an example-based super-resolution processor for receiving one or more high resolution replacement patch pictures generated from a static version of an input video sequence having motion, and performing example-based super-resolution to generate a reconstructed version of the static version of the input video sequence from the one or more high resolution replacement patch pictures. The reconstructed version of the static version of the input video sequence includes a plurality of pictures. The apparatus further includes an inverse image warper for receiving motion parameters for the input video sequence, and performing an inverse picture warping process based on the motion parameters to transform one or more of the plurality of pictures to generate a reconstruction of the input video sequence having the motion.

This application claims the benefit of U.S. Provisional Application Ser. No. 61/403086 entitled MOTION COMPENSATED EXAMPLE-BASED SUPER-RESOLUTION FOR VIDEO COMPRESSION filed on Sep. 10, 2010 (Technicolor Docket No. PU100190).

This application is related to the following co-pending, commonly-owned, patent applications:
(1) International (PCT) Patent Application Serial No. PCT/US11/000107 entitled A SAMPLING-BASED SUPER-RESOLUTION APPROACH FOR EFFICIENT VIDEO COMPRESSION filed on Jan. 20, 2011 (Technicolor Docket No. PU100004);
(2) International (PCT) Patent Application Serial No. PCT/US11/000117 entitled DATA

PRUNING FOR VIDEO COMPRESSION USING EXAMPLE-BASED SUPER-RESOLUTION filed on Jan. 21, 2011 (Technicolor Docket No. PU100014);
(3) International (PCT) Patent Application Serial No. ______ entitled METHODS AND APPARATUS FOR ENCODING VIDEO SIGNALS USING MOTION COMPENSATED EXAMPLE-BASED SUPER-RESOLUTION FOR VIDEO COMPRESSION filed on Sep. ______, 2011 (Technicolor Docket No. PU100190);
(4) International (PCT) Patent Application Serial No. ______ entitled METHODS AND APPARATUS FOR ENCODING VIDEO SIGNALS USING EXAMPLE-BASED DATA PRUNING FOR IMPROVED VIDEO COMPRESSION EFFICIENCY filed on Sep. ______, 2011 (Technicolor Docket No. PU100193);
(5) International (PCT) Patent Application Serial No. ______ entitled METHODS AND APPARATUS FOR DECODING VIDEO SIGNALS USING EXAMPLE-BASED DATA PRUNING FOR IMPROVED VIDEO COMPRESSION EFFICIENCY filed on Sep. ______, 2011 (Technicolor Docket No. PU100267);
(6) International (PCT) Patent Application Serial No. ______ entitled METHODS AND APPARATUS FOR ENCODING VIDEO SIGNALS FOR BLOCK-BASED MIXED-RESOLUTION DATA PRUNING filed on Sep. ______, 2011 (Technicolor Docket No. PU100194);
(7) International (PCT) Patent Application Serial No. ______ entitled METHODS AND APPARATUS FOR DECODING VIDEO SIGNALS FOR BLOCK-BASED MIXED-RESOLUTION DATA PRUNING filed on Sep. ______, 2011 (Technicolor Docket No. PU100268);
(8) International (PCT) Patent Application Serial No. ______ entitled METHODS AND APPARATUS FOR EFFICIENT REFERENCE DATA ENCODING FOR VIDEO COMPRESSION BY IMAGE CONTENT BASED SEARCH AND RANKING filed on Sep. ______, 2011 (Technicolor Docket No. PU100195);
(9) International (PCT) Patent Application Serial No. ______ entitled METHOD AND APPARATUS FOR EFFICIENT REFERENCE DATA DECODING FOR VIDEO COMPRESSION BY IMAGE CONTENT BASED SEARCH AND RANKING filed on Sep. ______, 2011 (Technicolor Docket No. PU110106);
(10) International (PCT) Patent Application Serial No. ______ entitled METHOD AND APPARATUS FOR ENCODING VIDEO SIGNALS FOR EXAMPLE-BASED DATA PRUNING USING INTRA-FRAME PATCH SIMILARITY filed on Sep. ______, 2011 (Technicolor Docket No. PU100196); and
(11) International (PCT) Patent Application Serial No. ______ entitled METHOD AND APPARATUS FOR DECODING VIDEO SIGNALS WITH EXAMPLE-BASED DATA PRUNING USING INTRA-FRAME PATCH SIMILARITY filed on Sep. ______, 2011 (Technicolor Docket No. PU100269).
(12) International (PCT) Patent Application Serial No. ______ entitled PRUNING DECISION OPTIMIZATION IN EXAMPLE-BASED DATA PRUNING COMPRESSION filed on Sep. ______, 2011 (Technicolor Docket No. PU10197).

The present principles relate generally to video encoding and decoding and, more particularly, to methods and apparatus for motion compensated example-based super-resolution for video compression.

In a previous approach—such as the one disclosed in Dong-Qing Zhang, Sitaram Bhagavathy, and Joan Llach, “Data pruning for video compression using example-based super-resolution,” filed as a co-pending, commonly-owned, U.S. Provisional Patent Application (Ser. No. 61/336516) on Jan. 22, 2010 (Technicolor docket number PU100014)—video data pruning for compression using example-based super-resolution (SR) was proposed. Example-based super-resolution for data pruning sends high-resolution (high-res) example patches and low-resolution (low-res) frames to the decoder. The decoder recovers the high-res frames by replacing the low-res patches with the example high-res patches.

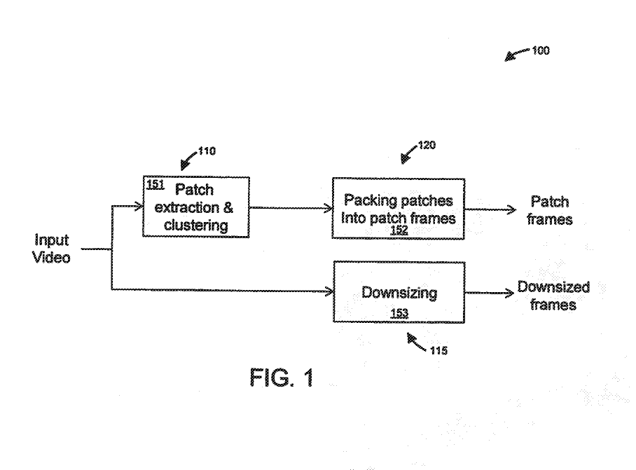

Turning to FIG. 1, one of the aspects of the previous approach is described. More specifically, a high-level block diagram of encoder side processing for example-based super resolution is indicated generally by the reference numeral 100. Input video is subjected to patch extraction and clustering at step 110 (by a patch extractor and clusterer 151) to obtain clustered patches. Moreover, the input video is also subjected to downsizing at step 115 (by a downsizer 153) to output downsized frames there from. Clustered patches are packed into patch frames at step 120 (by a patch packer 152) to output the (packed) patch frames there from.

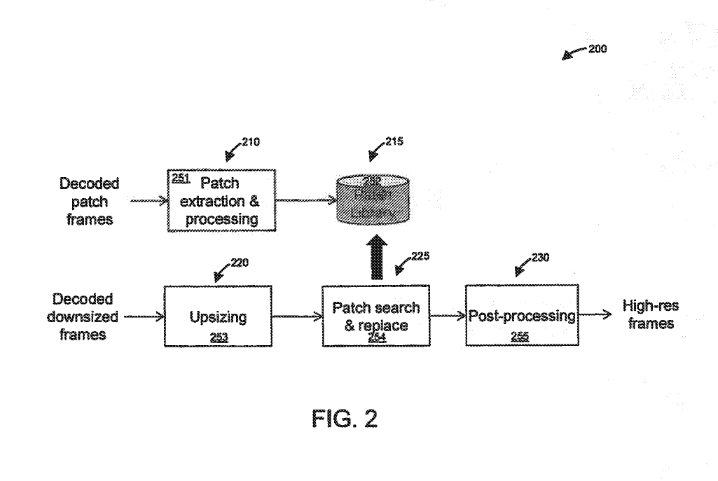

Turning to FIG. 2, another aspect of the previous approach is described. More specifically, a high-level block diagram of the decoder side processing for example-based super resolution is indicated generally by the reference numeral 200. Decoded patch frames are subject to patch extraction and processing at step 210 (by a patch extractor and processor 251) to obtain processed patches. The processed patches are stored at step 215 (by a patch library 252). Decoded down-sized frames are subject to upsizing at step 220 (by an upsizer 253) to obtain upsized frames. The upsized frames are subject to patch searching and replacement at step 225 (by a patch searcher and replacer 254) to obtain replacement patches. The replacement patches are subject to post-processing at step 230 (by a post-processor 255) to obtain high-resolution frames.

The method presented in the previous approach works well for static video (videos without significant background or foreground object motion). For example, experiments show that for certain types of static videos, compression efficiency can be increased using example-based super-resolution comparing to using the standalone video encoder such as, for example, an encoder in accordance with the International Organization for

Standardization/International Electrotechnical Commission (ISO/IEC) Moving Picture Experts Group-4 (MPEG-4) Part 10 Advanced Video Coding (AVC) Standard/International Telecommunication Union, Telecommunication Sector (ITU-T) H.264 Recommendation (hereinafter the “MPEG-4 AVC Standard”).

However, for videos with significant object or background motion, the compression efficiency using example-based super-resolution is often worse than that of using the standalone MPEG-4 AVC encoder. This is because for videos with significant motion, the clustering process for extracting representative patches typically generates substantially more redundant representative patches because of patch shifting and other transformation (e.g., zooming, rotation, and so forth), therefore increasing the number of the patch frames and decreasing the compression efficiency of the patch frames.

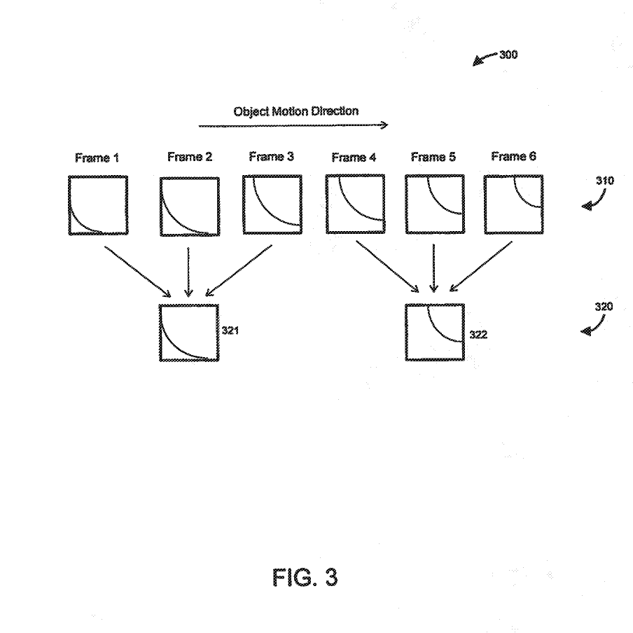

Turning to FIG. 3, a clustering process used in the previous approach for example-based super-resolution is indicated generally by the reference numeral 300. In the example of FIG. 3, the clustering process involves six frames (designated as Frame 1 through Frame 6). An object (in motion) is indicated by the curved line in FIG. 3. The clustering process 300 is shown with respect to an upper portion and a lower portion of FIG. 3. At the upper portion, co-located input patches 310 from consecutive frames of an input video sequence are shown. At the lower portion, representative patches 320 corresponding to clusters are shown. In particular, the lower portion shows a representative patch 321 of cluster 1, and a representative patch 322 of cluster 2.

In sum, example-based super resolution for data pruning sends high-resolution (also referred to herein as “high-res”) example patches and low-resolution (also referred to herein as “low-res”) frames to the decoder (see FIG. 1). The decoder recovers the high-resolution frames by replacing the low-resolution patches with the example high-resolution patches (see FIG. 2). However, as noted above, for videos with motion, the clustering process for extracting representative patches typically generates substantially more redundant representative patches because of patch shifting (see FIG. 3) and other transformation (such as zooming, rotation, etc.), therefore increasing the number of the patch frames and decreasing the compression efficiency of the patch frames.

This application discloses methods and apparatus for motion compensated example-based super-resolution for video compression with improved compression efficiency.

According to an aspect of the present principles, there is provided an apparatus for example-based super-resolution. The apparatus includes a motion parameter estimator for estimating motion parameters for an input video sequence having motion. The input video sequence includes a plurality of pictures. The apparatus also includes an image warper for performing a picture warping process that transforms one or more of the plurality of pictures to provide a static version of the input video sequence by reducing an amount of the motion based on the motion parameters. The apparatus further includes an example-based super-resolution processor for performing example-based super-resolution to generate one or more high-resolution replacement patch pictures from the static version of the video sequence. The one or more high-resolution replacement patch pictures are for replacing one or more low-resolution patch pictures during a reconstruction of the input video sequence.

According to another aspect of the present principles, there is provided a method for example-based super-resolution. The method includes estimating motion parameters for an input video sequence having motion. The input video sequence includes a plurality of pictures. The method also includes performing a picture warping process that transforms one or more of the plurality of pictures to provide a static version of the input video sequence by reducing an amount of the motion based on the motion parameters. The method further includes performing example-based super-resolution to generate one or more high-resolution replacement patch pictures from the static version of the video sequence. The one or more high-resolution replacement patch pictures are for replacing one or more low-resolution patch pictures during a reconstruction of the input video sequence.

According to still another aspect of the present principles, there is provided an apparatus for example-based super-resolution. The apparatus includes an example-based super-resolution processor for receiving one or more high resolution replacement patch pictures generated from a static version of an input video sequence having motion, and performing example-based super-resolution to generate a reconstructed version of the static version of the input video sequence from the one or more high resolution replacement patch pictures. The reconstructed version of the static version of the input video sequence includes a plurality of pictures. The apparatus also includes an inverse image warper for receiving motion parameters for the input video sequence, and performing an inverse picture warping process based on the motion parameters to transform one or more of the plurality of pictures to generate a reconstruction of the input video sequence having the motion.

According to a further aspect of the present principles, there is provided a method for example-based super-resolution. The method includes receiving motion parameters for an input video sequence having motion, and one or more high-resolution replacement patch pictures generated from a static version of the input video sequence. The method also includes performing example-based super-resolution to generate a reconstructed version of the static version of the input video sequence from the one or more high-resolution replacement patch pictures. The reconstructed version of the static version of the input video sequence includes a plurality of pictures. The method further includes performing an inverse picture warping process based on the motion parameters to transform one or more of the plurality of pictures to generate a reconstruction of the input video sequence having the motion.

According to a still further aspect of the present principles, there is provided an apparatus for example-based super-resolution. The apparatus includes means for estimating motion parameters for an input video sequence having motion. The input video sequence includes a plurality of pictures. The apparatus also includes means for performing a picture warping process that transforms one or more of the plurality of pictures to provide a static version of the input video sequence by reducing an amount of the motion based on the motion parameters. The apparatus further includes means for performing example-based super-resolution to generate one or more high-resolution replacement patch pictures from the static version of the video sequence. The one or more high-resolution replacement patch pictures are for replacing one or more low-resolution patch pictures during a reconstruction of the input video sequence.

According to an additional aspect of the present principles, there is provided an apparatus for example-based super-resolution. The apparatus includes means for receiving motion parameters for an input video sequence having motion, and one or more high-resolution replacement patch pictures generated from a static version of the input video sequence. The apparatus also includes means for performing example-based super-resolution to generate a reconstructed version of the static version of the input video sequence from the one or more high-resolution replacement patch pictures. The reconstructed version of the static version of the input video sequence includes a plurality of pictures. The apparatus further includes means for performing an inverse picture warping process based on the motion parameters to transform one or more of the plurality of pictures to generate a reconstruction of the input video sequence having the motion.

These and other aspects, features and advantages of the present principles will become apparent from the following detailed description of exemplary embodiments, which is to be read in connection with the accompanying drawings.

The present principles may be better understood in accordance with the following exemplary figures, in which:

FIG. 1 is a high-level block diagram showing encoder-side processing for example-based super resolution, in accordance with the previous approach;

FIG. 2 is a high-level block diagram showing decoder-side processing for example-based super resolution, in accordance with the previous approach;

FIG. 3 is a diagram showing a clustering process used for example-based super-resolution, in accordance with the previous approach;

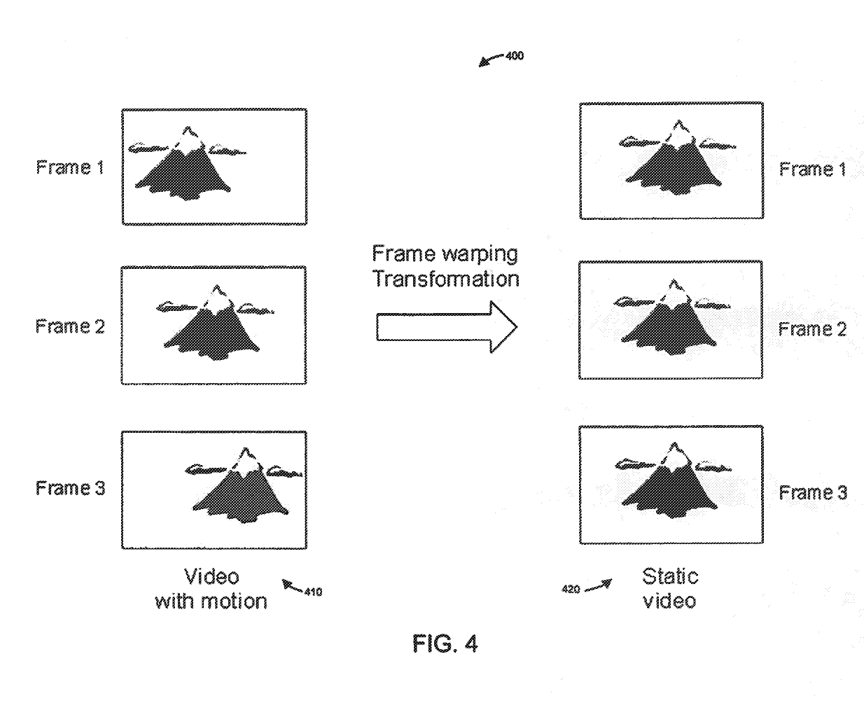

FIG. 4 is a diagram showing an exemplary transformation of a video with object motion to a static video, in accordance with an embodiment of the present principles;

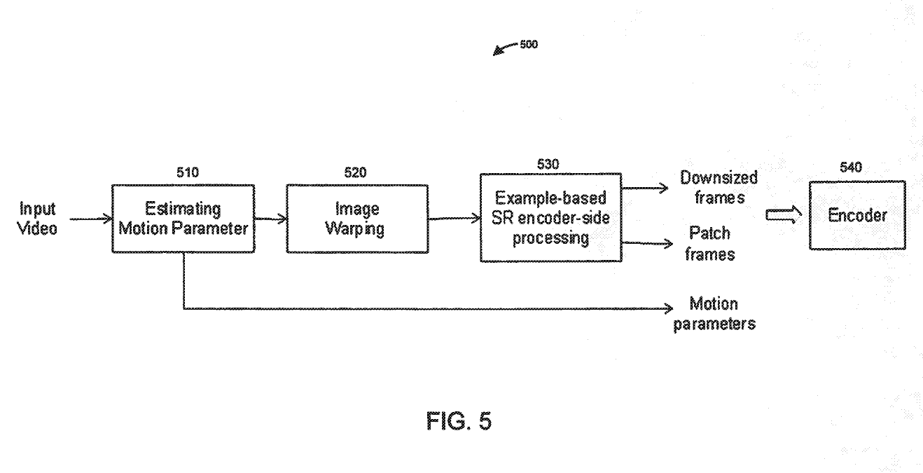

FIG. 5 is a block diagram showing an exemplary apparatus for motion compensated example-based super-resolution processing with frame warping for use in an encoder, in accordance with an embodiment of the present principles;

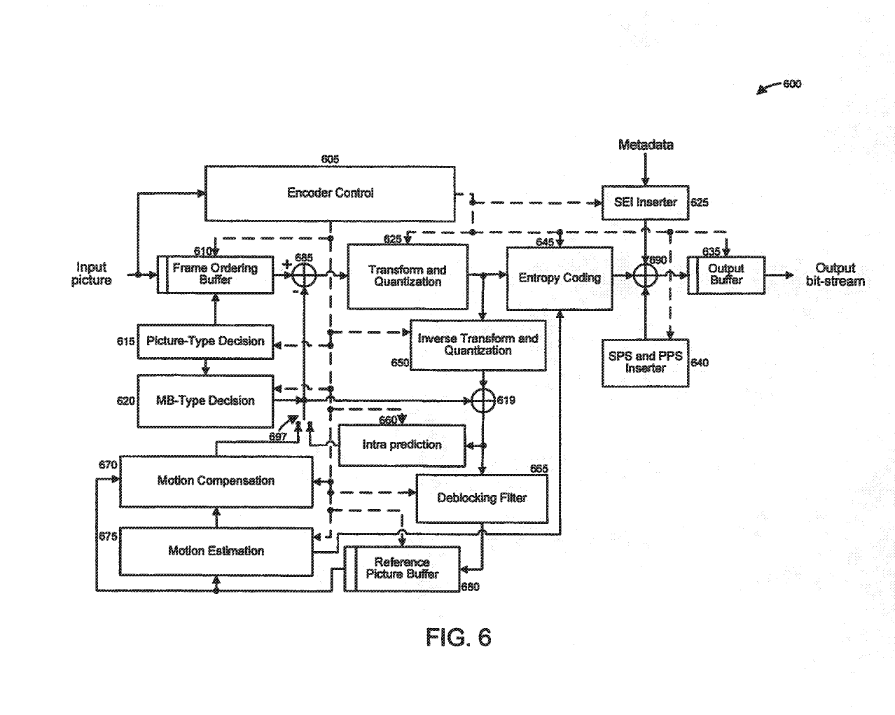

FIG. 6 is a block diagram showing an exemplary video encoder to which the present principles may be applied, in accordance with an embodiment of the present principles;

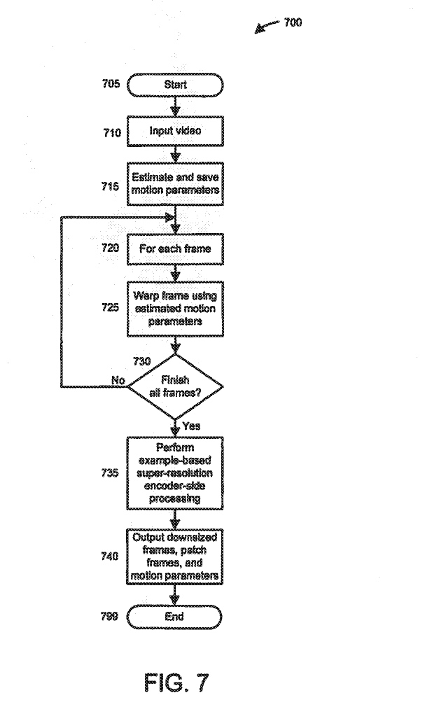

FIG. 7 is a flow diagram showing an exemplary method for motion compensated exampled-based super-resolution at an encoder, in accordance with an embodiment of the present principles;

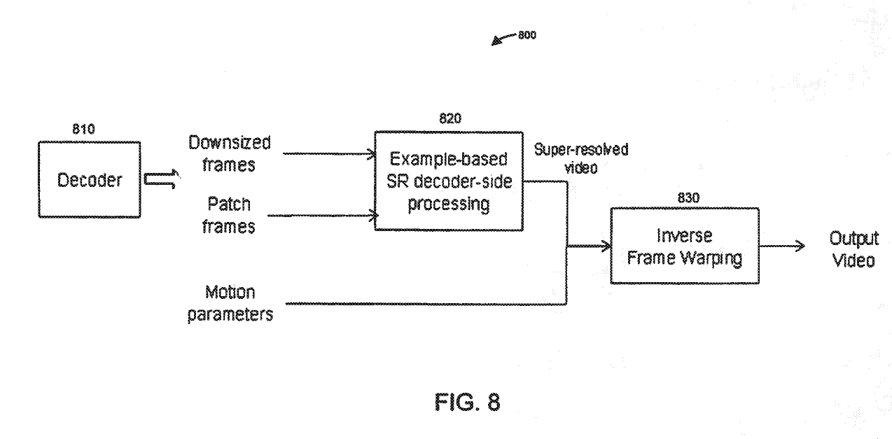

FIG. 8 is a block diagram showing an exemplary apparatus for motion compensated example-based super-resolution processing with inverse frame warping in a decoder, in accordance with an embodiment of the present principles;

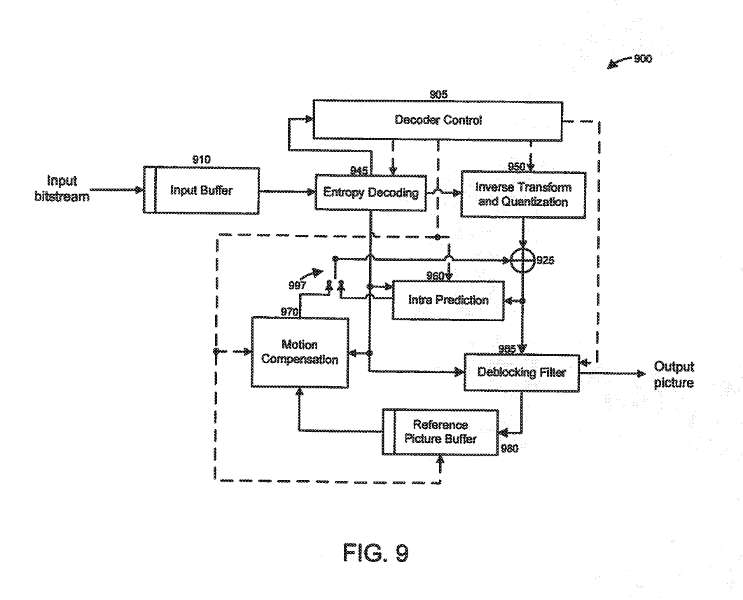

FIG. 9 is a block diagram showing an exemplary video decoder to which the present principles may be applied, in accordance with an embodiment of the present principles; and

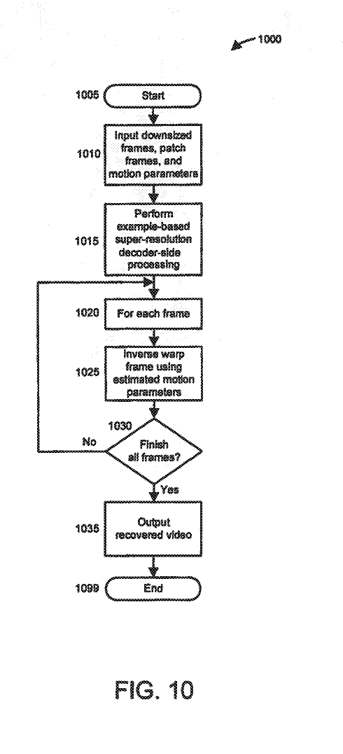

FIG. 10 is a flow diagram showing an exemplary method for motion compensated exampled-based super-resolution at a decoder, in accordance with an embodiment of the present principles.

The present principles are directed to methods and apparatus for motion compensated example-based super-resolution for video compression.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Also, as used herein, the words “picture” and “image” are used interchangeably and refer to a still image or a picture from a video sequence. As is known, a picture may be a frame or a field.

As noted above, the present principles are directed to methods and apparatus for motion compensated exampled-based super-resolution video compression. Advantageously, the present principles provide a way to reduce the number of redundant representative patches and increase the compression efficiency.

In accordance with the present principles, this application discloses a concept of transforming a video segment with significant background and object motion to a relatively static video segment. More specifically, in FIG. 4, an exemplary transformation of a video with object motion to a static video is indicated generally by the reference numeral 400. The transformation 400 involves a frame warping transformation that is applied to Frame 1, Frame 2, and Frame 3 of the video with object motion 410 to obtain Frame 1, Frame 2, and Frame 3 of the static video 420. The transformation 400 is performed before the clustering process (i.e., the encoder-side processing component of the example-based super-resolution method) and the encoding process. The transformation parameters are then sent to the decoder side for recovery. Since the example-based super-resolution method would result in higher compression efficiency for static videos, and the size of the transformation parameter data is usually very small, by transforming the videos with motion to static videos, it is possible to potentially gain compression efficiency for videos with motion.

Turning to FIG. 5, an exemplary apparatus for motion compensated example-based super-resolution processing with frame warping for use in an encoder is indicated generally by the reference numeral 500. The apparatus 500 includes a motion parameter estimator 510 having a first output in signal communication with an input of an image warper 520. An output of the image warper 520 is connected in signal communication with an input of an example-based super-resolution encoder-side processor 530. A first output of the example-based super-resolution encoder-side processor 530 is connected in signal communication with an input of an encoder 540, and provides downsized frames thereto. A second output of the example-based super-resolution encoder-side processor 530 is connected in signal communication with the input of the encoder 540, and provides patch frames thereto. A second output of the motion parameter estimator 510 is available as an output of the apparatus 500, for providing motion parameters. An input of the motion parameter estimator 510 is available as an input to the apparatus 500, for receiving an input video. An output (not shown) of the encoder 540 is available as a second output of the apparatus 500, for outputting a bitstream. The bitstream may include, for example, encoded downsized frames, encoder patch frames, and motion parameters.

It is to be appreciated that the functions performed by the encoder 540, namely encoding, may be omitted, with the downsized frames, the patch frames, and the motion parameters being sent to the decoder side without any compression. However, to save bit rates, the downsized frames and the patch frames are preferably compressed (by the encoder 540) before being sent to the decoder side. Moreover, in another embodiment, the motion parameter estimator 510, the image warper 520, and the example-based super-resolution encoder-side processor 530 may be included in, and part of, a video encoder.

Thus, at the encoder side, before the clustering process is performed, motion estimation is carried out (by the motion parameter estimator 510) and a frame warping process is applied (by the image warper 520) to transform frames with moving objects or background to a relatively static video. The parameters extracted from the motion estimation process are sent to the decoder side through a separate channel.

Turning to FIG. 6, an exemplary video encoder to which the present principles may be applied is indicated generally by the reference numeral 600. The video encoder 600 includes a frame-ordering buffer 610 having an output in signal communication with a non-inverting input of a combiner 685. An output of the combiner 685 is connected in signal communication with a first input of a transformer and quantizer 625. An output of the transformer and quantizer 625 is connected in signal communication with a first input of an entropy coder 645 and a first input of an inverse transformer and inverse quantizer 650. An output of the entropy coder 645 is connected in signal communication with a first non-inverting input of a combiner 690. An output of the combiner 690 is connected in signal communication with a first input of an output buffer 635.

A first output of an encoder controller 605 is connected in signal communication with a second input of the frame ordering buffer 610, a second input of the inverse transformer and inverse quantizer 650, an input of a picture-type decision module 615, a first input of a macroblock-type (MB-type) decision module 620, a second input of an intra prediction module 660, a second input of a deblocking filter 665, a first input of a motion compensator 670, a first input of a motion estimator 675, and a second input of a reference picture buffer 680.

A second output of the encoder controller 605 is connected in signal communication with a first input of a Supplemental Enhancement Information (SEI) inserter 630, a second input of the transformer and quantizer 625, a second input of the entropy coder 645, a second input of the output buffer 635, and an input of the Sequence Parameter Set (SPS) and Picture Parameter Set (PPS) inserter 640.

An output of the SEI inserter 630 is connected in signal communication with a second non-inverting input of the combiner 690.

A first output of the picture-type decision module 615 is connected in signal communication with a third input of the frame ordering buffer 610. A second output of the picture-type decision module 615 is connected in signal communication with a second input of a macroblock-type decision module 620.

An output of the Sequence Parameter Set (SPS) and Picture Parameter Set (PPS) inserter 640 is connected in signal communication with a third non-inverting input of the combiner 690.

An output of the inverse quantizer and inverse transformer 650 is connected in signal communication with a first non-inverting input of a combiner 619. An output of the combiner 619 is connected in signal communication with a first input of the intra prediction module 660 and a first input of the deblocking filter 665. An output of the deblocking filter 665 is connected in signal communication with a first input of a reference picture buffer 680. An output of the reference picture buffer 680 is connected in signal communication with a second input of the motion estimator 675 and a third input of the motion compensator 670. A first output of the motion estimator 675 is connected in signal communication with a second input of the motion compensator 670. A second output of the motion estimator 675 is connected in signal communication with a third input of the entropy coder 645.

An output of the motion compensator 670 is connected in signal communication with a first input of a switch 697. An output of the intra prediction module 660 is connected in signal communication with a second input of the switch 697. An output of the macroblock-type decision module 620 is connected in signal communication with a third input of the switch 697. The third input of the switch 697 determines whether or not the “data” input of the switch (as compared to the control input, i.e., the third input) is to be provided by the motion compensator 670 or the intra prediction module 660. The output of the switch 697 is connected in signal communication with a second non-inverting input of the combiner 619 and an inverting input of the combiner 685.

A first input of the frame ordering buffer 610 and an input of the encoder controller 605 are available as inputs of the encoder 600, for receiving an input picture. Moreover, a second input of the Supplemental Enhancement Information (SEI) inserter 630 is available as an input of the encoder 600, for receiving metadata. An output of the output buffer 635 is available as an output of the encoder 100, for outputting a bitstream.

It is to be appreciated that encoder 540 from FIG. 5 may be implemented as encoder 600.

Turning to FIG. 7, an exemplary method for motion compensated example-based super-resolution at an encoder is indicated generally by the reference numeral 700. The method 700 includes a start block 705 that passes control to a function block 710. The function block 710 inputs a video with object motion, and passes control to a function block 715. The function block 715 estimates and saves motion parameters for the input video with object motion, and passes control to a loop limit block 720. The loop limit block 720 performs a loop for each frame, and passes control to a function block 725. The function block 725 warps the current frame using the estimated motion parameters, and passes control to a decision block 730. The decision block 730 determines whether or not processing of all frames is finished. If the processing of all frames is finished, then control is passed to a function block 735. Otherwise, control is returned to the function block 720. The function block 735 performs example-based super-resolution encoder-side processing, and passes control to a function block 740. The function block 740 outputs downsized frames, patch frames, and motion parameters, and passes control to an end block 799.

Turning to FIG. 8, an exemplary apparatus for motion compensated example-based super-resolution processing with inverse frame warping in a decoder is indicated generally by the reference numeral 800. The apparatus 800, including decoder 810, processes the signals generated by the apparatus 500, including encoder 540, described above. The apparatus 800 includes a decoder 810 having an output in signal communication with a first input and a second input of an example-based super-resolution decoder-side processor 820, and respectively provides (decoded) downsized frames and patch frames thereto. An output of the example-based super-resolution decoder-side processor 820 is also connected in signal communication with the input of the inverse frame warper 830, for providing super-resolved video thereto. An output of the inverse frame warper 830 is available as an output of the apparatus 800, for outputting video. An input of the inverse frame warper 830 is available for receiving the motion parameters.

It is to be appreciated that the functions performed by the decoder 810, namely decoding, may be omitted, with the downsized frames and the patch frames being received by the decoder side without any compression. However, to save bit rates, the downsized frames and the patch frames are preferably compressed at the encoder side before being sent to the decoder side. Moreover, in another embodiment, the example-based super-resolution decoder-side processor 820 and inverse frame warper may be included in, and part of, a video decoder.

Thus, at the decoder side, after the frames are recovered by example-based super-resolution, a reverse warping process is conducted to transform the recovered video segment to the coordinate systems of the original video. The reverse warping process uses the motion parameters estimated at and sent from the encoder side.

Turning to FIG. 9, an exemplary video decoder to which the present principles may be applied is indicated generally by the reference numeral 900. The video decoder 900 includes an input buffer 910 having an output connected in signal communication with a first input of an entropy decoder 945. A first output of the entropy decoder 945 is connected in signal communication with a first input of an inverse transformer and inverse quantizer 950. An output of the inverse transformer and inverse quantizer 950 is connected in signal communication with a second non-inverting input of a combiner 925. An output of the combiner 925 is connected in signal communication with a second input of a deblocking filter 965 and a first input of an intra prediction module 960. A second output of the deblocking filter 965 is connected in signal communication with a first input of a reference picture buffer 980. An output of the reference picture buffer 980 is connected in signal communication with a second input of a motion compensator 970.

A second output of the entropy decoder 945 is connected in signal communication with a third input of the motion compensator 970, a first input of the deblocking filter 965, and a third input of the intra predictor 960. A third output of the entropy decoder 945 is connected in signal communication with an input of a decoder controller 905. A first output of the decoder controller 905 is connected in signal communication with a second input of the entropy decoder 945. A second output of the decoder controller 905 is connected in signal communication with a second input of the inverse transformer and inverse quantizer 950. A third output of the decoder controller 905 is connected in signal communication with a third input of the deblocking filter 965. A fourth output of the decoder controller 905 is connected in signal communication with a second input of the intra prediction module 960, a first input of the motion compensator 970, and a second input of the reference picture buffer 980.

An output of the motion compensator 970 is connected in signal communication with a first input of a switch 997. An output of the intra prediction module 960 is connected in signal communication with a second input of the switch 997. An output of the switch 997 is connected in signal communication with a first non-inverting input of the combiner 925.

An input of the input buffer 910 is available as an input of the decoder 900, for receiving an input bitstream. A first output of the deblocking filter 965 is available as an output of the decoder 900, for outputting an output picture.

It is to be appreciated that decoder 810 from FIG. 8 may be implemented as decoder 900.

Turning to FIG. 10, an exemplary method for motion compensated example-based super-resolution at a decoder is indicated generally by the reference numeral 1000. The method 1000 includes a start block 1005 that passes control to a function block 1010. The function block 1010 inputs downsized frames, patch frames, and motion parameters, and passes control to a function block 1015. The function block 1015 performs example-based super-resolution decoder-side processing, and passes control to a loop limit block 1020. The loop limit block 1020 performs a loop for each frame, and passes control to a function block 1025. The function block 1025 performs inverse frame warping using the received motion parameters, and passes control to a decision block 1030. The decision block 1030 determines whether or not processing of all frames is finished. If the processing of all frames is finished, then control is passed to a function block 1035. Otherwise, control is returned to the function block 1020. The function block 1035 outputs recovered video, and passes control to an end block 1099.

The input video is divided into Groups of Frames (GOF). Each GOF is a basic unit for motion estimation, frame warping and example-based super-resolution. One of the frames (e.g., the frame in the middle or beginning) in a GOF is chosen as a reference frame for motion estimation). The GOFs can have either fixed or variable lengths.

### Motion Estimation

Motion estimation is used to estimate the displacement of the pixels in a frame relative to a reference frame. Since the motion parameters have to be sent to the decoder side, the number of motion parameters should be as small as possible. Therefore, it is preferable to choose a certain parametric motion model that is governed by a small number of parameters. For example, in the current system disclosed herein, a planar motion model that can be characterized by 8 parameters is employed. Such a parametric motion model is able to model the global motion between frames, such as translation, rotation, affine warp, projective transformation, and so forth, which is common in many different types of videos. For example, when the camera pans, the camera panning results in translational motion. Foreground object motion may not be very well captured by this model, but if the foreground objects are small and the background motion is significant, then the transformed video would remain mostly static. Of course, the use of a parametric motion model capable of being characterized by 8 parameters is merely illustrative and, thus, other parametric motion models capable of being characterized by more than 8 parameters, less than 8 parameters, or even with 8 parameters where one or more are different than the aforementioned model, may also be used in accordance with the teachings of the present principles, while maintaining the spirit of the present principles.

Without loss of generality, it is presumed that the reference frame is H₁, and the rest of the frames in a GOF are Hᵢ (i=2, 3, . . . , N). The global motion between two frames Hᵢ and frame Hⱼ actually can be characterized by transformations that move the pixels in Hᵢ to the positions of their corresponding pixels in Hⱼ, or vice versa. The transformation from Hᵢ to Hⱼ is denoted by Θᵢⱼ, and its parameters are denoted by θᵢⱼ. The transformation Θᵢⱼ can then be used to align (or warp) Hᵢ to Hⱼ (or vice versa using the inverse model Θⱼᵢ=Θᵢⱼ⁻¹).

Global motion can be estimated using a variety of models and methods and, hence, the present principles are not limited to any particular method and/or model of estimating global motion. As an example, one commonly used model (the model used in the current system referring to herein) is the projective transformation given by:

$${x}^{′} = \frac{{a}_{1} x + {a}_{2} y + {a}_{3}}{{c}_{1} x + {c}_{2} y + 1} , {y}^{′} = \frac{{b}_{1} x + {b}_{2} y + {b}_{3}}{{c}_{1} x + {c}_{2} y + 1} \qquad ( 1 )$$

The above equations give the new position (x′, y′) in Hⱼ to which the pixel at (x, y) in Hᵢ has moved. Thus, the eight model parameters Θᵢⱼ={a₁, a₂, a₃, b₁, b₂, b₃, c₁, c₂} describe the motion from Hᵢ to Hⱼ. The parameters are usually estimated by first determining a set of point correspondences between the two frames and then using a robust estimation framework, such as RANdom SAmple Consensus (RANSAC) or its variants—for example, the one described in M. A. Fischler and R. C. Bolles, “Random Sample Consensus: A Paradigm for Model Fitting with Applications to Image Analysis and Automated Cartography,” Communications of the ACM, vol. 24, 1981, pp. 381-395 and P. H. S. Torr and A. Zisserman, “MLESAC: A New Robust Estimator with Application to Estimating Image Geometry,” Journal of Computer Vision and Image Understanding, vol. 78, no. 1, 2000, pp. 138-156. Point correspondences between frames can be determined by a number of methods, e.g., extracting and matching SIFT (Scale-Invariant Feature Transform) features—such as the one described in D. G. Lowe, “Distinctive image features from scale-invariant keypoints,” International Journal of Computer Vision, vol. 2, no. 60, 2004, pp. 91-110—or using optical flow—such as the one described in M. J. Black and P. Anandan, “The robust estimation of multiple motions: Parametric and piecewise-smooth flow fields,” Computer Vision and Image Understanding, vol. 63, no. 1, 1996, pp. 75-104.

The global motion parameters are used to warp the frames (excluding the reference frame) in a GOF to align with the reference frame. Therefore, the motion parameters between each frame Hᵢ (i=2, 3, . . . , N) to the reference frame (H₁) have to be estimated. The transformation is invertible and the inverse transformation Θⱼᵢ=Θᵢⱼ⁻¹ describes the motion from Hⱼ to Hᵢ. The inverse transformation is used to warp the resulted frames back to the original frame. The inverse transformation is used at the decoder side for recovering the original video segment. The transformation parameters are compressed and sent through a side channel to the decoder side to facilitate the video recovery process.

Apart from the global motion model, other motion estimation methods such as block-based methods can be used in accordance with the present principles to achieve more accuracy. The block-based methods divide a frame into blocks, and estimate motion models for each block. However, it takes significantly more bits to describe motion using a block-based model.

### Frame Warping and Inverse Frame Warping

After the motion parameters are estimated, at the encoder side, a frame warping process is performed to align the non-reference frames to the reference frame. However, it is possible that some areas in a video frame do not obey the global motion model described above. By applying frame warping, these areas will be transformed along with the rest of the areas in the frame. However, this does not create a major problem if these areas are small, because warping of these areas only creates artificial motions of these areas in the warped frame. As long as these areas with artificial motion are small, it would not result in a significant increase of representative patches therefore, overall, the warping process would still be able to reduce the total number of representative patches. Also, the artificial motion of the small areas will be reversed by the inverse warping process.

The inverse frame warping process is conducted at the decoder side to warp the recovered frame from the example-based super-resolution component back to the original coordinate system.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
an example-based super-resolution processor for receiving one or more high resolution replacement patch pictures generated from a static version of an input video sequence having motion, and performing example-based super-resolution to generate a reconstructed version of said static version of said input video sequence from said one or more high resolution replacement patch pictures, said reconstructed version of said static version of said input video sequence including a plurality of pictures; and
an inverse image warper for receiving motion parameters for said input video sequence, and performing an inverse picture warping process based on said motion parameters to transform one or more of said plurality of pictures to generate a reconstruction of said input video sequence having said motion.

2. The apparatus of claim 1, wherein said example-based super-resolution processor is further for receiving one or more downsized pictures from said input video sequence, said one or more downsized pictures for use in generating said reconstruction of said input video sequence having said motion.

3. The apparatus of claim 1, further comprising a decoder for decoding said motion parameters and said one or more high resolution replacement patch pictures from a bitstream.

4. The apparatus of claim 1, wherein said apparatus is included in a video decoder module.

5. The apparatus of claim 1, wherein said inverse picture warping process aligns a reference picture from among a group of pictures comprised in said plurality of pictures with non-reference pictures from among said group of pictures.

6. A method, comprising:
receiving motion parameters for an input video sequence having motion, and one or more high resolution replacement patch pictures generated from a static version of said input video sequence;
performing example-based super-resolution to generate a reconstructed version of said static version of said input video sequence from said one or more high resolution replacement patch pictures, said reconstructed version of said static version of said input video sequence comprising a plurality of pictures; and
performing an inverse picture warping process based on said motion parameters to transform one or more of said plurality of pictures to generate a reconstruction of said input video sequence having said motion.

7. The method of claim 6, wherein performing said example-based super-resolution comprises receiving one or more downsized pictures generated from said input video sequence, said one or more downsized pictures for use in generating said reconstruction of said input video sequence having said motion.

8. The method of claim 6, further comprising decoding said motion parameters and said one or more high resolution replacement patch pictures from a bitstream.

9. The method of claim 6, wherein said method is performed in a video decoder.

10. The method of claim 6, wherein said inverse picture warping process aligns a reference picture from among a group of pictures comprised in said plurality of pictures with non-reference pictures from among said group of pictures.

11. An apparatus, comprising:
means for receiving motion parameters for an input video sequence having motion, and one or more high resolution replacement patch pictures generated from a static version of said input video sequence;
means for performing example-based super-resolution to generate a reconstructed version of said static version of said input video sequence from said one or more high resolution replacement patch pictures, said reconstructed version of said static version of said input video sequence comprising a plurality of pictures; and
means for performing an inverse picture warping process based on said motion parameters to transform one or more of said plurality of pictures to generate a reconstruction of said input video sequence having said motion.

12. The apparatus of claim 11, wherein said means for performing said example-based super-resolution is further for receiving one or more downsized pictures generated from said input video sequence, said one or more downsized pictures for use in generating said reconstruction of said input video sequence having said motion.

13. The apparatus of claim 11, further comprising means for decoding said motion parameters and said one or more high-resolution replacement patch pictures from a bitstream.

14. The apparatus of claim 11, wherein said inverse picture warping process aligns a reference picture from among a group of pictures comprised in aid plurality of pictures with non-reference pictures from among said group of pictures.
